(19) United States
(12) Patent Application Publication
(10) Pub. No.: US 2014/0241265 A1
(43) Pub. Date: Aug. 28, 2014

(54) COMPONENT CARRIER TRAFFIC MAPPING

(71) Applicants: Ravikumar V. Pragada, Collegeville, PA (US); Douglas R. Castor, Norristown, PA (US); Samian Kaur, Plymouth Meeting, PA (US); Stephen E. Terry, Northport (IS)

(72) Inventors: Ravikumar V. Pragada, Collegeville, PA (US); Douglas R. Castor, Norristown, PA (US); Samian Kaur, Plymouth Meeting, PA (US); Stephen E. Terry, Northport (IS)

(73) Assignee: INTERDIGITAL PATENT HOLDINGS, INC., Wilmington, DE (US)

(21) Appl. No.: 14/131,682

(22) PCT Filed: Jul. 6, 2012
(86) PCT No.: PCT/US2012/045801

§ 371 Date: Mar. 23, 2014

Related U.S. Application Data
(60) Provisional application No. 61/505,853, filed on Jul. 8, 2011.

(51) Int. Cl. H04W 72/04

(52) U.S. Cl. CPC H04W 72/04
USPC 370/329

(57) ABSTRACT

Data traffic may be mapped such that it may be routed via a component carrier. The data traffic may be mapped based on QoS, traffic offload, or the like. This may provide the ability to map certain data to specific component carriers. For example, this may provide a user subscription model with the ability to map one or more services to license exempt (LE) carriers, but not to other carriers. As another example, a user downloading a high definition movie may not want this to be counted towards his or her monthly quota on a licensed carriers or may want to pay flat rate to access supplementary carriers for such services. Allowing data to be mapped such that it may be routed via a component carrier via a component carrier may allow the user to map the data for the high definition movie to a LE carrier.

### CROSS REFERENCE TO RELATED APPLICATIONS

This application claims the benefit of U.S. Provisional Application No. 61/505,853, filed Jul. 8, 2011, entitled “Component Carrier Traffic Mapping,” which is incorporated by reference as if fully set forth herein.

### BACKGROUND

As the demand for additional spectrum is constantly on the rise, it may be beneficial to enable users to seamlessly and opportunistically roam across various wireless access networks in the search for more throughput or cheaper bandwidth. Secondary utilization of unused spectrum, be it unlicensed, lightly licensed, or licensed, requires efficient detection and sharing without harmful interference with other users.

### SUMMARY

Disclosed herein are systems and methods for mapping logical channel data and/or EPS/radio bearers to specific carriers in a set of component carriers. Described herein are methods to provide mapping of data based on quality of service (QoS) or other bases (e.g., traffic offload) to specific component carriers (CC) in a long term evolution (LTE) network. Also described herein are revisions to logical channel prioritization (LCP) procedures.

Embodiments of the systems and methods described herein may be used in carrier aggregation frameworks utilizing carrier in both licensed and license exempt spectrum. Embodiments may also be directed to user equipment device-to-device (D2D) relays, which may be UE-to-UE relays, that may be used under an LTE-Advanced (LTE-A) framework. The component carriers may comprise a primary carrier and a supplemental carrier, and the supplemental carrier may be in a license-exempt spectrum range. One basis to selectively map traffic to a specific component carrier may be to avoid mapping real-time or near real-time traffic to supplementary carriers. Billing and/or accounting factors may also be used to influence the data traffic mapping to specific component carriers.

A method may comprise obtaining a plurality of data blocks, each data block associated with a respective one of a plurality of logical channels; allocating radio transmission resources for transmission of the plurality of data blocks by mapping each data block to one of a plurality of component carriers based in part on a logical channel prioritization parameter associated with the data block and based in part on component carrier preference data; and transmitting a plurality of component carriers.

The data block mapping may be performed by a logical channel prioritization algorithm that may utilize the component carrier preference data. The component carrier preference data may comprise a component carrier preference list for at least one logical channel and/or a component carrier exclusion list. Each channel may have its own list, or the list for one or more logical channels may be null (empty).

Prioritization may be given to avoiding segmentation of protocol data units (PDUs). That is, the mapping of data blocks to the component carriers may be based in part to prevent data block segmentation such that a data block may be mapped to a non-preferred component carrier if data block segmentation may be needed on the preferred component carrier and may not be required on the non-preferred component carrier.

The component carrier preference mechanism may be used by the UE on the uplink as well as by the evolved Node B (eNB) for the downlink. Thus, the UE may transmit a radio resource control (RRC) message requesting configuration of a logical channel and the carrier component preference data may be obtained for use by the UE.

A method, which may be implemented by an eNB, may comprise transmitting to a mobility management entity (MME) a non-access stratum (NAS) message that may be derived from a radio resource control (RRC) message that may be received from a user equipment (UE) requesting configuration of a logical channel. The carrier component preference data may be obtained for use by the eNB.

A method may comprise transmitting to an MME a NAS message that may be derived from an RRC message received from a UE that may request configuration of a logical channel. MME component carrier preference data may be recieved and the component carrier preference data may be transmitted to the UE for use in UE data transmissions over a plurality of component carriers.

Methods and systems may be provided for a UE to request grants on specific component carriers. As described herein, a UE may request grants on specific component carriers, such as supplementary carriers. Although embodiments described herein may be discussed in terms of uplink procedures, but they may apply equally well to downlink direction embodiments.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1A depicts a system diagram of an example communications system in which one or more disclosed embodiments may be implemented.

FIG. 1B depicts a system diagram of an example wireless transmit/receive unit (WTRU) that may be used within the communications system illustrated in FIG. 1A.

FIG. 1C depicts a system diagram of an example radio access network and an example core network that may be used within the communications system illustrated in FIG. 1A.

FIG. 1D depicts a system diagram of an example radio access network and an example core network that may be used within the communications system illustrated in FIG. 1A.

FIG. 1E depicts a system diagram of an example radio access network and an example core network that may be used within the communications system illustrated in FIG. 1A.

FIG. 2 depicts an example embodiment for LTE-A spectrum aggregation using licensed and license exempt bands.

FIG. 3 depicts example types of UEs that may be used in a UE relay scenario.

FIGS. 4A and 4B depict example embodiments of protocol stack views that may have different HARQ mechanisms.

FIG. 5 depicts an example embodiment of a local channel prioritization (LCP) procedure.

FIG. 6 depicts an example embodiment for downlink logical and transport channels for capacity relay.

FIG. 7 depicts an example embodiment for an uplink logical and transport channel for capacity relay.

FIG. 8 depicts an example embodiment of a modified logical channel prioritization (LCP) for device-to-device (D2D) capacity mode.

FIG. 9 depicts an example embodiment of a medium access control (MAC) structure overview from a UE perspective.

FIG. 10 depicts an example embodiment of transport block processing in uplink (UL) for a supplementary carrier.

FIG. 11 depicts an example embodiment of a modified LCP for license exempt (LE) carrier aggregation.

FIG. 12 depicts an example embodiment for macro plus hotspot coverage.

### DETAILED DESCRIPTION

Disclosed herein are systems and methods for mapping logical channel data and/or EPS/radio bearers to carriers in a set of component carriers. Described herein are methods to provide mapping of data based on quality of service (QoS) or other bases (e.g., traffic offload) to component carriers (CC) in a long term evolution (LTE) network. Also described herein are revisions to logical channel prioritization (LCP) procedures.

Mapping of data may be based on QoS or other bases, such as traffic offload, reasons (for ex., traffic offload) to component carriers (CC). This may be done, for example, to improve quality of experience (QoE), decrease latency, and/or improve data throughput for a user under a carrier aggregation framework for both licensed and license exempt spectrum. This may be also applicable to D2D relays, such as UE-to-UE relays, developed under LTE-A framework.

Unlicensed bands and/or secondary use of lightly licensed bands may be utilized in a LTE-A carrier aggregation framework. For example, a framework may allow LTE-A devices to use licensed-exempt, unlicensed, or lightly licensed spectrums as a new bands. These bands may be used in addition to existing LTE-A bands, for example, to transmit to a user equipment (UE) in a downlink direction, or to the base-station in an uplink direction. Additional bandwidth may be of an unlicensed band, lightly licensed or a licensed band used by another primary communication system. D2D relays, such as UE-to-UE relays, may also be used increase throughput to and from a terminal UE and to improve the capacity of the network as a whole.

Data traffic may be mapped such that it may be routed via a component carrier. The data traffic may be mapped based on QoS, traffic offload, or the like. This may provide the ability to map certain data to specific component carriers. For example, this may provide a user subscription model with the ability to map one or more services to LE carriers, but not to other carriers. As another example, a user downloading a high definition movie may not want this to be counted towards his or her monthly quota on a licensed carrier or might want to pay flat rate to access supplementary carriers for such services. Allowing data to be mapped such that it may be routed via a component carrier via a component carrier may allow the user to map the data for the high definition movie to a LE carrier.

Data may also be mapped such that it may prevent it from being routed to a component carrier. For supplementary carriers, even though a channel may be allocated, for example a UL soft-grant may be provided, channel unavailability may occur when other secondary users occupy the channel. Thus, real-time or pseudo real-time guaranteed bit rate (GBR) traffic may not be mapped to supplementary carriers to prevent the GBR traffic from being routed to a supplementary carrier.

Maximum bit rate (MBR) GBR data may be mapped to component carriers. This may be done, for example, to allow GBR traffic to be sent using licensed carriers. Additionally, (MBR-GBR) traffic may be sent using supplementary carriers.

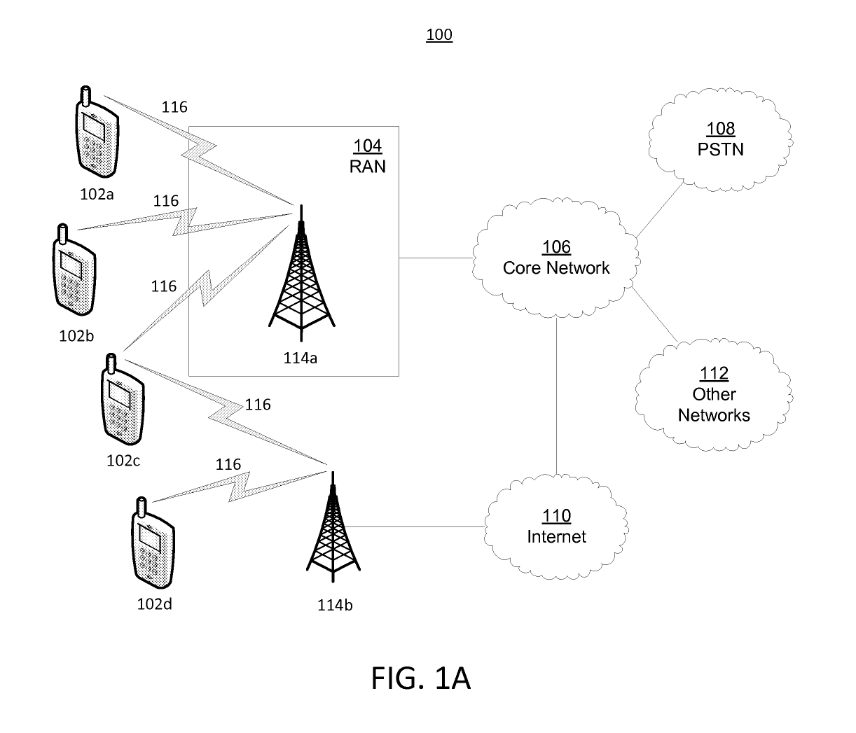

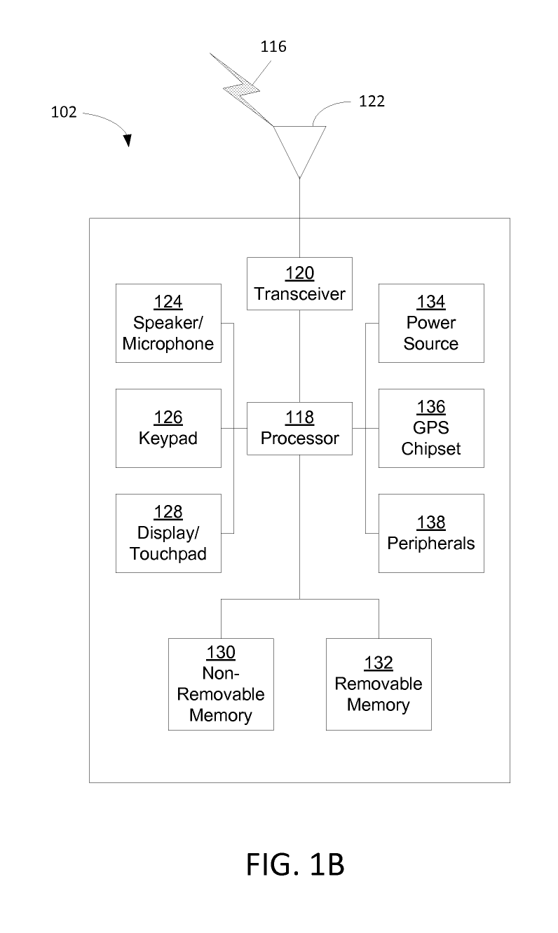

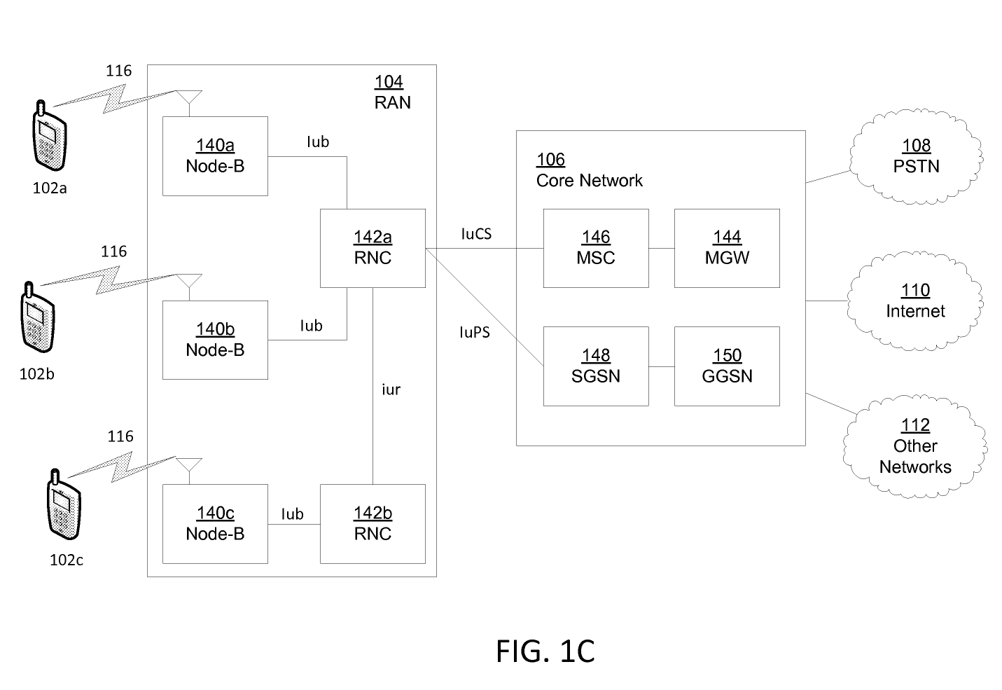

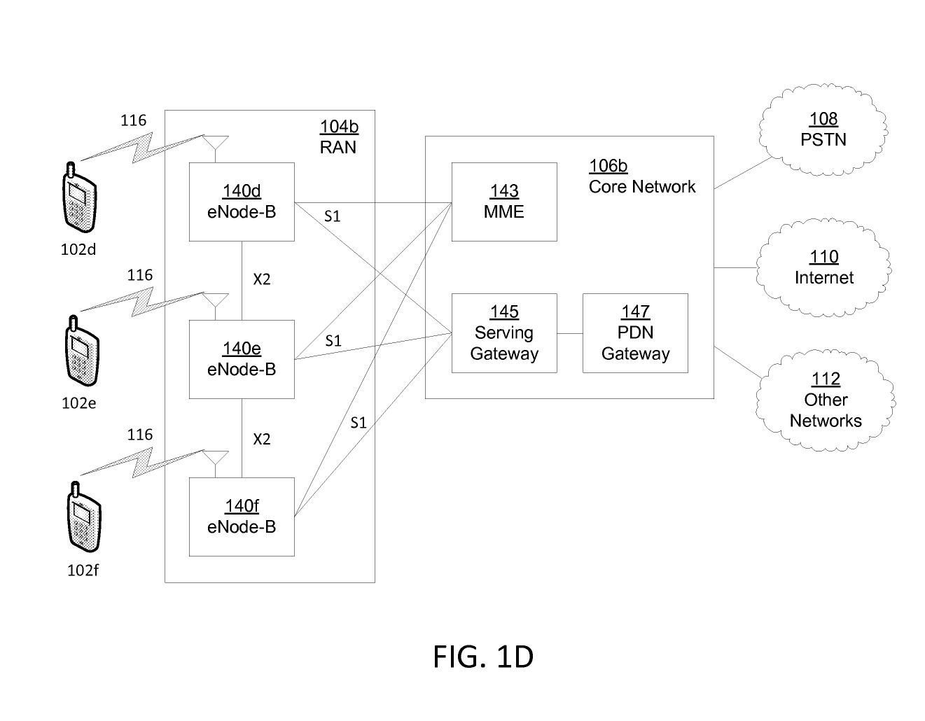

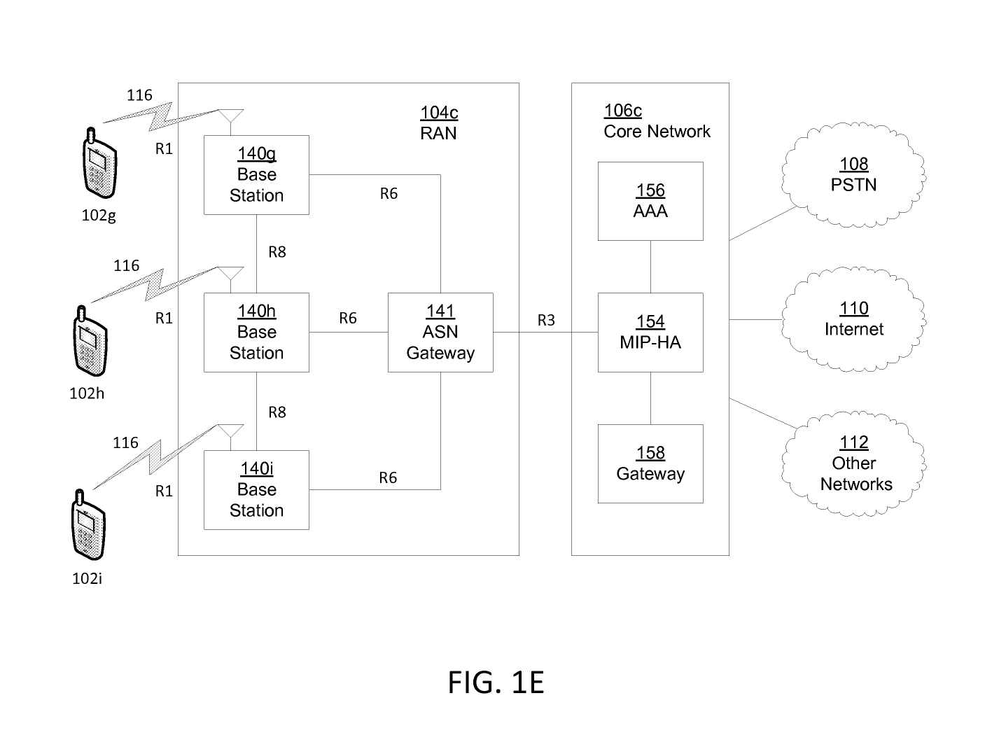

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106a according to an embodiment. As noted above, the RAN 104 may employ a UTRA radio technology to communicate with the WTRUs 102a, 102b, 102c over the air interface 116. The RAN 104 may also be in communication with the core network 106a. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106a shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106a, it will be appreciated that any one of these elements may be owned and/or operated by an entity other than the core network operator.

The RNC 142a in the RAN 104 may be connected to the MSC 146 in the core network 106a via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106a via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106a may also be connected to the networks 112, which may include other wired or wireless networks that are owned and/or operated by other service providers.

FIG. 1D is a system diagram of the RAN 104b and the core network 106b according to an embodiment. As noted above, the RAN 104b may employ an E-UTRA radio technology to communicate with the WTRUs 102d, 102e, 102f over the air interface 116. The RAN 104 may also be in communication with the core network 106b.

The RAN 104 may include eNode-Bs 140d, 140e, 140f, though it will be appreciated that the RAN 104 may include any number of eNode-Bs while remaining consistent with an embodiment. The eNode-Bs 140d, 140e, 140f may each include one or more transceivers for communicating with the WTRUs 102d, 102e, 102f over the air interface 116. In one embodiment, the eNode-Bs 140d, 140e, 140f may implement MIMO technology. Thus, the eNode-B 140d, for example, may use multiple antennas to transmit wireless signals to, and receive wireless signals from, the WTRU 102d.

Each of the eNode-Bs 140d, 140e, 140f may be associated with a particular cell (not shown) and may be configured to handle radio resource management decisions, handover decisions, scheduling of users in the uplink and/or downlink, and the like. As shown in FIG. 1D, the eNode-Bs 140d, 140e, 140f may communicate with one another over an X2 interface.

The core network 106b shown in FIG. 1D may include a mobility management gateway (MME) 143, a serving gateway 145, and a packet data network (PDN) gateway 147. While each of the foregoing elements are depicted as part of the core network 106b, it will be appreciated that any one of these elements may be owned and/or operated by an entity other than the core network operator.

The MME 143 may be connected to each of the eNode-Bs 140d, 140e, 140f in the RAN 104b via an S1 interface and may serve as a control node. For example, the MME 143 may be responsible for authenticating users of the WTRUs 102d, 102e, 102f, bearer activation/deactivation, selecting a particular serving gateway during an initial attach of the WTRUs 102d, 102e, 102f, and the like. The MME 143 may also provide a control plane function for switching between the RAN 104b and other RANs (not shown) that employ other radio technologies, such as GSM or WCDMA.

The serving gateway 145 may be connected to each of the eNode Bs 140d, 140e, 140f in the RAN 104b via the S1 interface. The serving gateway 145 may generally route and forward user data packets to/from the WTRUs 102d, 102e, 102f. The serving gateway 145 may also perform other functions, such as anchoring user planes during inter-eNode B handovers, triggering paging when downlink data is available for the WTRUs 102d, 102e, 102f, managing and storing contexts of the WTRUs 102d, 102e, 102f, and the like.

The serving gateway 145 may also be connected to the PDN gateway 147, which may provide the WTRUs 102d, 102e, 102f with access to packet-switched networks, such as the Internet 110, to facilitate communications between the WTRUs 102d, 102e, 102f and IP-enabled devices.

The core network 106b may facilitate communications with other networks. For example, the core network 106b may provide the WTRUs 102d, 102e, 102f with access to circuit-switched networks, such as the PSTN 108, to facilitate communications between the WTRUs 102d, 102e, 102f and traditional land-line communications devices. For example, the core network 106b may include, or may communicate with, an IP gateway (e.g., an IP multimedia subsystem (IMS) server) that serves as an interface between the core network 106b and the PSTN 108. In addition, the core network 106b may provide the WTRUs 102d, 102e, 102f with access to the networks 112, which may include other wired or wireless networks that are owned and/or operated by other service providers.

FIG. 1E is a system diagram of the RAN 104c and the core network 106c according to an embodiment. The RAN 104c may be an access service network (ASN) that employs IEEE 802.16 radio technology to communicate with the WTRUs 102g, 102h, 102i over the air interface 116. As will be further discussed below, the communication links between the different functional entities of the WTRUs 102g, 102h, 102i, the RAN 104c, and the core network 106c may be defined as reference points.

As shown in FIG. 1E, the RAN 104c may include base stations 140g, 140h, 140i, and an ASN gateway 141, though it will be appreciated that the RAN 104 may include any number of base stations and ASN gateways while remaining consistent with an embodiment. The base stations 140g, 140h, 140i may each be associated with a particular cell (not shown) in the RAN 104c and may each include one or more transceivers for communicating with the WTRUs 102g, 102h, 102i over the air interface 116. In one embodiment, the base stations 140g, 140h, 140i may implement MIMO technology. Thus, the base station 140g, for example, may use multiple antennas to transmit wireless signals to, and receive wireless signals from, the WTRU 102g. The base stations 140g, 140h, 140i may also provide mobility management functions, such as handoff triggering, tunnel establishment, radio resource management, traffic classification, quality of service (QoS) policy enforcement, and the like. The ASN Gateway 141 may serve as a traffic aggregation point and may be responsible for paging, caching of subscriber profiles, routing to the core network 106c, and the like.

The air interface 116 between the WTRUs 102g, 102h, 102i and the RAN 104c may be defined as an R1 reference point that implements the IEEE 802.16 specification. In addition, each of the WTRUs 102g, 102h, 102i may establish a logical interface (not shown) with the core network 106c. The logical interface between the WTRUs 102g, 102h, 102i and the core network 106c may be defined as an R2 reference point, which may be used for authentication, authorization, IP host configuration management, and/or mobility management.

The communication link between each of the base stations 140g, 140h, 140i may be defined as an R8 reference point that includes protocols for facilitating WTRU handovers and the transfer of data between base stations. The communication link between the base stations 140g, 140h, 140i and the ASN gateway 141 may be defined as an R6 reference point. The R6 reference point may include protocols for facilitating mobility management based on mobility events associated with each of the WTRUs 102g, 102h, 100i.

As shown in FIG. 1E, the RAN 104 may be connected to the core network 106c. The communication link between the RAN 104c and the core network 106c may defined as an R3 reference point that includes protocols for facilitating data transfer and mobility management capabilities, for example. The core network 106c may include a mobile IP home agent (MIP-HA) 144, an authentication, authorization, accounting (AAA) server 156, and a gateway 158. While each of the foregoing elements are depicted as part of the core network 106c, it will be appreciated that any one of these elements may be owned and/or operated by an entity other than the core network operator.

The MIP-HA may be responsible for IP address management, and may enable the WTRUs 102g, 102h, 102i to roam between different ASNs and/or different core networks. The MIP-HA 154 may provide the WTRUs 102g, 102h, 102i with access to packet-switched networks, such as the Internet 110, to facilitate communications between the WTRUs 102g, 102h, 102i and IP-enabled devices. The AAA server 156 may be responsible for user authentication and for supporting user services. The gateway 158 may facilitate interworking with other networks. For example, the gateway 158 may provide the WTRUs 102g, 102h, 102i with access to circuit-switched networks, such as the PSTN 108, to facilitate communications between the WTRUs 102g, 102h, 102i and traditional landline communications devices. In addition, the gateway 158 may provide the WTRUs 102g, 102h, 102i with access to the networks 112, which may include other wired or wireless networks that are owned and/or operated by other service providers.

Although not shown in FIG. 1E, it will be appreciated that the RAN 104c may be connected to other ASNs and the core network 106c may be connected to other core networks. The communication link between the RAN 104c the other ASNs may be defined as an R4 reference point, which may include protocols for coordinating the mobility of the WTRUs 102g, 102h, 102i between the RAN 104c and the other ASNs. The communication link between the core network 106c and the other core networks may be defined as an R5 reference, which may include protocols for facilitating interworking between home core networks and visited core networks.

One aspect of LTE-A is the notion of carrier aggregation (CA). The DL and UL transmission bandwidths will therefore exceed 20 MHz in R8 LTE, e.g. 40 MHz or even up to 100 MHz. In LTE Rel10, component carriers (CC) were introduced to enable the spectrum aggregation feature. A UE may simultaneously receive or transmit one or multiple CCs depending on its capabilities and channel availability: A Rel-10 UE with reception and/or transmission capabilities for CA can simultaneously receive and/or transmit on multiple CCs corresponding to multiple serving cells; A Rel-8/9 UE can receive on a single CC and transmit on a single CC corresponding to one serving cell only. CA is supported for both contiguous and non-contiguous CCs with each CC limited to a maximum of 110 Resource Blocks in the frequency domain using the Rel-8/9 numerology.

In some embodiments described herein, license-exempt spectrum carrier aggregation may be provided under a LTE-A framework. For example, to support license-exempt spectrum carrier aggregation, the LTE-Advanced component carrier framework maybe extended whereby a primary carrier in licensed spectrum may provide control and connection establishment, and a new component carrier in licensed-exempt spectrum may provide bandwidth extension.

In a licensed spectrum, the licensed spectrum system may be able to control transmissions in a channel and may manage the air interface. In an unlicensed system, there may be may be transmissions that may be outside the control of the licensed system since users of the unlicensed spectrum may be able to transmit at any time. To account for possible interference, a device that may use the unlicensed spectrum may use the channel when the device senses that there is little interference. A supplementary carrier may be used to provide additional bandwidth when possible.

In a license-exempt spectrum, such as television white space (TVWS), rules and policies may be determined with regard to when a channel may be considered free. These polices may be in addition to those used in unlicensed systems. This may involve querying a database via higher layer protocols to determine when a channel may be available or may be free of interference. For example, FCC rules may enable secondary (or unlicensed) users to transmit on TV band, as long as their transmissions do not affect primary users. The primary users on TV band may include digital TV signals, wireless microphones, or the like. To prevent the normal distributions of digital TV signal from interfering from unlicensed users, the FCC authorizes several TVWS database administrators to maintain TVWS databases. These databases may contain the information about the location and transmission conditions of digital TV towers. An unlicensed user may need to check the TVWS database to obtain a list of available TVWS channels at its location before it may transmit on the TVWS channels.

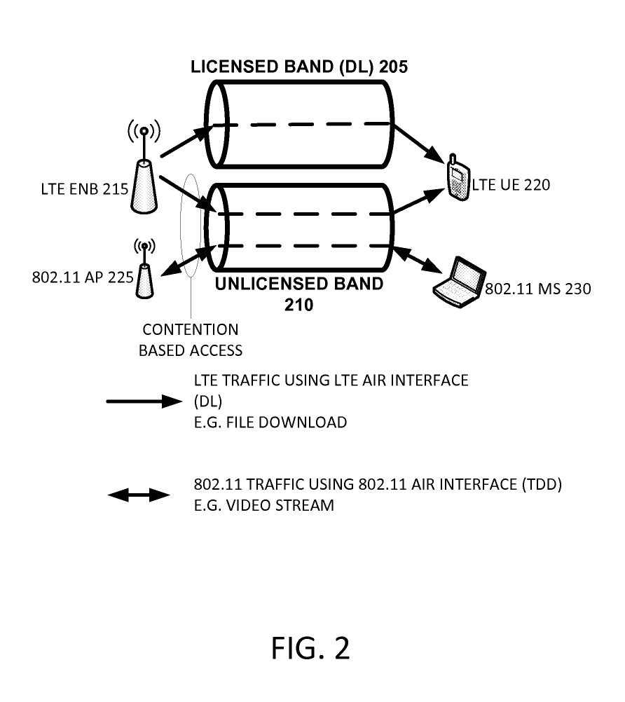

FIG. 2 depicts an example embodiment for LTE-A spectrum aggregation using licensed and license exempt bands. As shown in FIG. 2, licensed bands 205 and unlicensed bands 210 may be utilized for communications between an eNB, such as LTE eNB 215, and a UE, such as LTE UE 220. Licensed bands 205 and unlicensed bands 210 may also be utilized for communications between an AP, such as 802.11AP 225, and a UE, such as 802.11 MS 230. The component carriers operating in the license-exempt, such as the industrial scientific and medical radio band (ISM), unlicensed national information infrastructure (UNIT), television whitespace (TVWS), or the like, may spectrum operate with certain restrictions. A new carrier type for operation in the license-exempt spectrum, which may be referred to as a “Supplementary Carrier” may be introduced. The Supplementary Carrier may not be backward compatible. The Supplementary Carrier may extend LTE-A Carrier Aggregation into the license-exempt spectrum. The supplementary carrier may be operated as a single carrier (stand-alone) and may be a part of a component carrier set where at least one of the carriers in the set may be a stand-alone-capable carrier. The Supplementary Carrier may also be operated as multiple carriers.

Supplementary Carriers may be subject to “listen-before-talk” or sensing to determine suitability before transmission. This may result in the implementation of several feature changes compared to a Rel-10 secondary component carrier. Examples of some differences, which in part may define the Supplementary Carrier, are given in Table 1:

TABLE 1
Examples of Some Feature Differences between Rel-10 CC and Supplementary CC

| Feature | Rel-10 secondary CC | Supplementary CC |
|---|---|---|
| DL Channel | NB assumes exclusive channel | NB may not assume exclusive channel |
| Access | usage (except as coordinated by | usage, and may perform sensing prior |
| | ICIC procedures) | to transmission |
| UL Channel | UE assumes exclusive channel | UE cannot assume exclusive channel |
| Access (UL | reservation for fixed or semi- | usage, and may perform sensing prior |
| Grant) | persistent period. | to transmission |
| UL HARQ | Synchronous | May be synchronous or asynchronous |
| Synchro- | CC are backward compatible and | May not include synchronization |
| nization | include synchronization channel | channels |
| Signals | (P-SCH, S-SCH) | |
| System | Each CC broadcasts system | System information may be provided |
| information | information | using dedicated signaling on the |
| | | associated licensed (primary CC) |
| Control | Each CC has PDCCH, PCFICH, | Control channels may be mapped to |
| channel | PHICH (downlink) and PUCCH | a primary CC in the licensed band, and |
| | (uplink) control channels | cross-carrier scheduling may be used |
| Reference | Common reference symbols | CSI-RS transmission may be affected by |
| symbols | (CSI-RS) are always transmitted | Sensing: in an example, the power |
| | | and/or periodicity may be reduced |
| | | to avoid impact to other devices. |
| | | In another example, CSI-RS trans- |
| | | mission may occur if prior sensing |
| | | indicates the channel may be clear. |
| | | In another example, the CSI-RS |
| | | may continue to be transmitted |
| | | in a Rel-10 compatible manner. |
| Frame | Secondary CC's are synchronized | May be offset in time from primary CC |
| Timing | and time aligned to primary | |

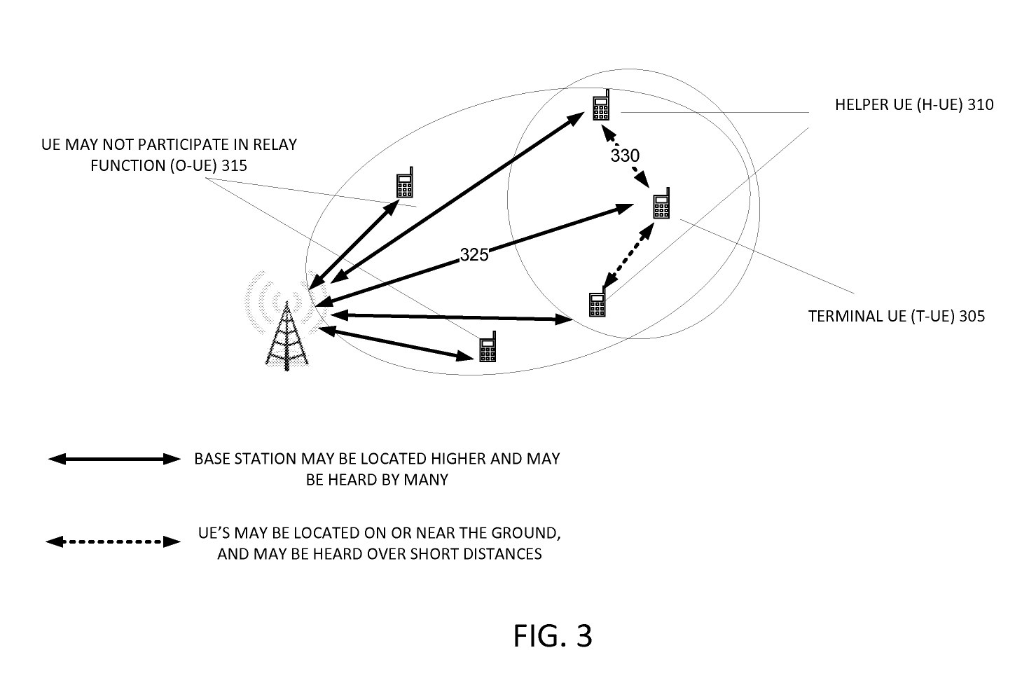

FIG. 3 depicts example types of UEs that may be used in a UE relay scenario. D2D relays may be provided. For example, a D2D Relay topology may be provided that may include direct communications between UEs. The D2D relay may be used to increase throughput to and from the terminal UE (T-UE), such as T-UE 305, and the capacity of the network. For example, a UE, such as T-UE 305, may not have a very good radio link with an eNB, such as eNB 320. This may be because T-UE 305 may be inside a building. As shown in FIG. 3 at 10, there may be others UEs that may be in the vicinity and may have better direct links. These UEs may act as helper UEs (H-UEs) and may increase the throughput to T-UE 305 by relaying data from and to eNB 320. The eNB-to-T-UE direct link may be active and may provide sufficient signal quality as to enable T-UE 305 to receive broadcast, paging and unicast control signaling from eNB 320. The eNB-to-T-UE direct link may also provide sufficient signal quality as to enable eNB 320 to receive PHY and to enable higher layer control signaling from T-UE 305. User data may also be communicated directly from eNB 320 to T-UE 305. T-UE 205 may receive data directly from eNB 320 even while operating in conjunction with an H-UE.

T-UE 305 may be considered to be anchored to (or camped on) eNB 320. This may give eNB 320 the ability to schedule the cross-link (XL) transmissions and may indicate this to T-UE 305. This may prevent a H-UE at 310 from transmitting system information and other signals that may be needed to support camping.

As shown in FIG. 3, a D2D relay capacity system may include two kinds of radio links; a traditional radio link (TRL) and a cross-link (XL). A TRL may be shown at 325 and may be a radio link between an eNB, such as eNB 320, and UE, such as T-UE 305. A XL may be shown at 330 and may be a D2D radio link, such as a UE-to-UE radio link between two UEs. The eNB may share its spectral resources between both of these wireless links. The resources allocated for crosslinks may be reused multiple times within the same cell beyond the reuse that MIMO techniques may allow. For a given connection, a UE may take on the role of an H-UE or T-UE. An H-UE, shown at 310, may be responsible for helping deliver data to or from a T-UE, such as T-UE 305. An H-UE may be an intermediate node between eNB 320 and T-UE 3-5. T-UE 305 may receive help from an H-UE. As shown at 315, UEs that may not assume the role of an H-UE or T-UE may utilize traditional radio links and may be referred to as an O-UE (other UE).

In capacity mode, service connections may originate from or terminate at the eNB. Additionally, communications may be restricted, for example, to a maximum of two hops. In this embodiment, both T-UE and H-UE direct links with the eNB may support PHY as well as higher layer signaling. The H-UE help may be used to support T-UE user data at rates that may be substantially higher than possible through the direct link.

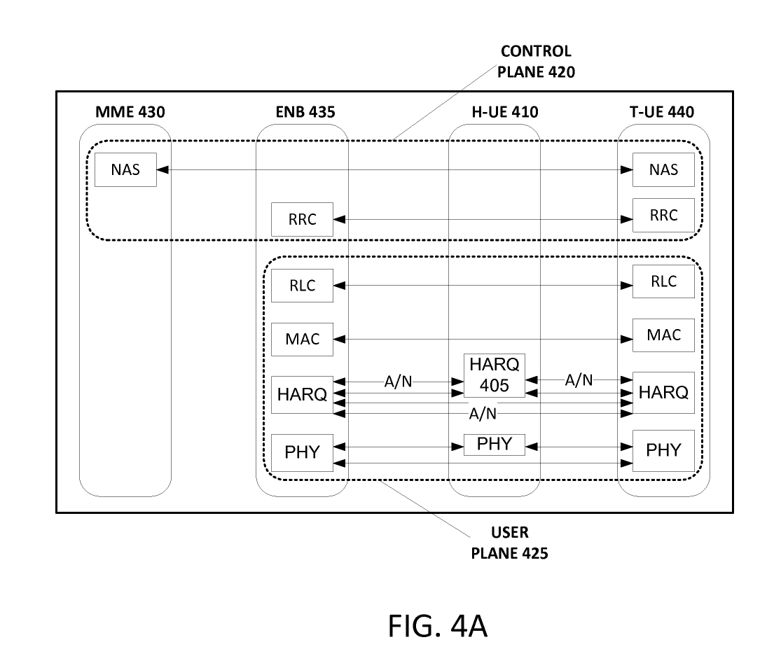

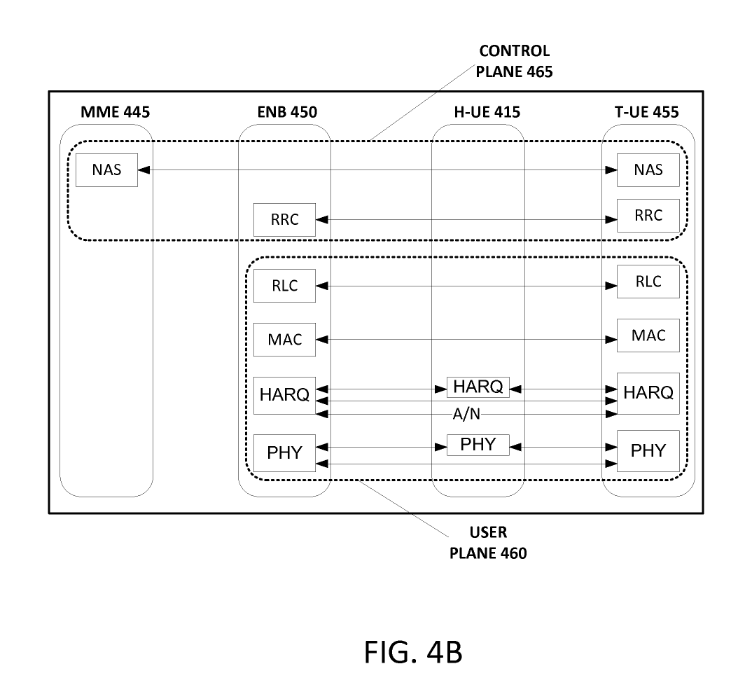

FIGS. 4A and 4B depict example embodiments of protocol stack views that may have different HARQ mechanisms. For example, FIGS. 4A and 4B may depict the protocol stacks for control and user planes along with their termination points. Control plane termination points shown in FIGS. 4A and 4B may be similar to LTE-A REL-10 (without relays). Termination points shown in FIGS. 4A and 4B may differ for hybrid automatic repeat request (HARQ) and physical (PHY) layers in user plane compared to REL-10.

As shown in FIG. 4A, a protocol stack may include non-access stratum (NAS), radio resource control (RRC), radio link control (RLC), medium access control (MAC), HARQ, and PHY layers. The protocol stack allow for communication between MME 430, eNB 435, H-UE 410, and/or T-UE 440. For example, MME 430, eNB 435, H-UE 410, and/or T-UE 440 may communicate using control plane 420. As another example, eNB 435, H-UE 410, and/or T-UE 440 may communicate using user plane 425. As shown in FIG. 4A, at 405, the HARQ entity at H-UE 410 may perform both the decode-forward as well as acknowledgement functions.

As shown in FIG. 4B, a protocol stack may include NAS, RRC, RLC, MAC, HARQ, and PHY layers. The protocol stack allow for communication between MME 445, eNB 450, H-UE 415, and/or T-UE 455. For example, MME 445, eNB 450, H-UE 415, and/or T-UE 455 may communicate using control plane 465. As another example, eNB 450, H-UE 415, and/or T-UE 455 may communicate using user plane 460. As shown in FIG. 4B, H-UE 415 may perform the decode-forward function, but not the acknowledgement function.

A UE may be configured with one primary cell (PCell) and zero or more secondary cells (SCells). If the UE is configured with one or more SCells, there are multiple DL-SCH and there may be multiple UL-SCH per UE; one DL-SCH and UL-SCH on the PCell, one DL-SCH and zero or one UL-SCH for each SCell.

Data traffic may be mapped such that it may be routed via a component carrier or transport channels. The data traffic may be mapped based on QoS, traffic offload, or the like. This may provide the ability to map certain data to specific component carriers. For example, this may provide a user subscription model with the ability to map one or more services to LE carriers, but not to other carriers. As another example, a user downloading a high definition movie may not want this to be counted towards his or her monthly quota on a licensed carriers or might want to pay flat rate to access supplementary carriers for such services. Allowing data to be mapped such that it may be routed via a component carrier via a component carrier may allow the user to map the data for the high definition movie to a LE carrier. As another example, in a license-exempt carrier aggregation framework, real-time or near real-time traffic may be mapped to supplementary carriers. This may be done, for example, using mechanisms that may consider the dynamic nature of supplementary carriers and may enable the mapping specific data to a given component carriers(s).

Data may also be mapped such that it may prevent it from being routed to a component carrier. For supplementary carriers, even though a channel may be allocated, for example a UL soft-grant may be provided, channel unavailability may occur when other secondary users occupy the channel. Thus, real-time or pseudo real-time guaranteed bit rate (GBR) traffic may not be mapped to supplementary carriers to prevent the GBR traffic from being routed to a supplementary carrier.

Maximum bit rate (MBR) GBR data may be mapped to component carriers. This may be done, for example, to allow GBR traffic to be sent using licensed carriers. Additionally, (MBR-GBR) traffic may be sent using supplementary carriers.

A UE may request grants on specific component carriers, such as supplementary carriers. This may be performed based on a higher layer service.

In LTE-A REL-10, there is one-to-one mapping between EPS bearer and radio bearer. One radio bearer maps to one logical channel or two logical channels for radio link control acknowledged (RLC-AM) mode. If a radio bearer is mapped to two logical channels for RLC-AM, one logical channel is for carrying purely RLC control information and the second logical channel will be for carrying higher layer data. Each logical channel is associated with a logical channel priority, which will dictate the prioritization provided in the access stratum. In addition, there is one UL-SCH mapped to PUSCH and one DL-SCH mapped to PDSCH.

Described herein are methods to map traffic, based on QoS or other reasons, to be routed via specific component carriers or transport channels. This may be done, for example, to extend LTE-A REL-10, to allow traffic to be mapped. Data may be mapped to a one or more component carriers and/or transport channels. Data may be prevented from being mapped to one or more component carriers and/or transport channels. MBR-GBR data may be mapped to one or more component carriers and/or transport channels.

In some embodiments, this may be achieved via a method to signal, for each data radio bearer (DRB) or signaling radio bearer which component carriers (or transport channels) may be preferred, which component carriers (or transport channels) may not be preferred for GBR traffic, which component carriers (or transport channels) may be used for traffic (such as MBR-GBR traffic), or any combination thereof. Other factors as described herein may also be used.

A logical channel prioritization (LCP) module may be updated to enable mapping of data to specific component carrier(s). Updates to LCP may be explained using preferredTrChList and refrainTrChList terminology. A preferredTrChList may be a list of transport channels (or component carriers) that may be preferred for this radio bearer. A refrainTrChList may be a list of transport channels (or component carriers) that a radio bearer may not be allowed to be mapped to. Even though updates to the LCP module may be explained in terms of “preferredTrChList” and “refrainTrChList”, it should be clear to one skilled in the art that this component carrier preference data or information may be provided to the UE in several different ways. For example, “preferredTrChList” and “refrainTrChList” may be provided for each data radio bearer during configuration. As another example, for each component carrier (cell) configured, the network may signal a list of data radio bearers (RB) (or logical channels) that may be preferred for this component carrier/transport channel and/or data RBs that may not be allowed to be mapped for this component carrier/transport channel. As another example, for each component carrier (cell) configured, a network may signal a list of Logical channel groups (LCGs) that may be preferred and a list of LCGs that may not be allowed to be mapped for this component carrier/transport channel. These LCGs may be the same as those that may be used for BSR reporting, or they may be completely independent of LCGs defined for BSR reporting. As another example, a priority order may be assigned for the transport channels or component carriers in preferredTrChList”.

A network may signal the “preferredTrChList” and “refrainTrChList” lists or similar component carrier preference data/information at configuration/reconfiguration time. A UE may autonomously build the “preferredTrChList” and “refrainTrChList” lists based on characteristics of the traffic flows and component carriers that are configured by the network.

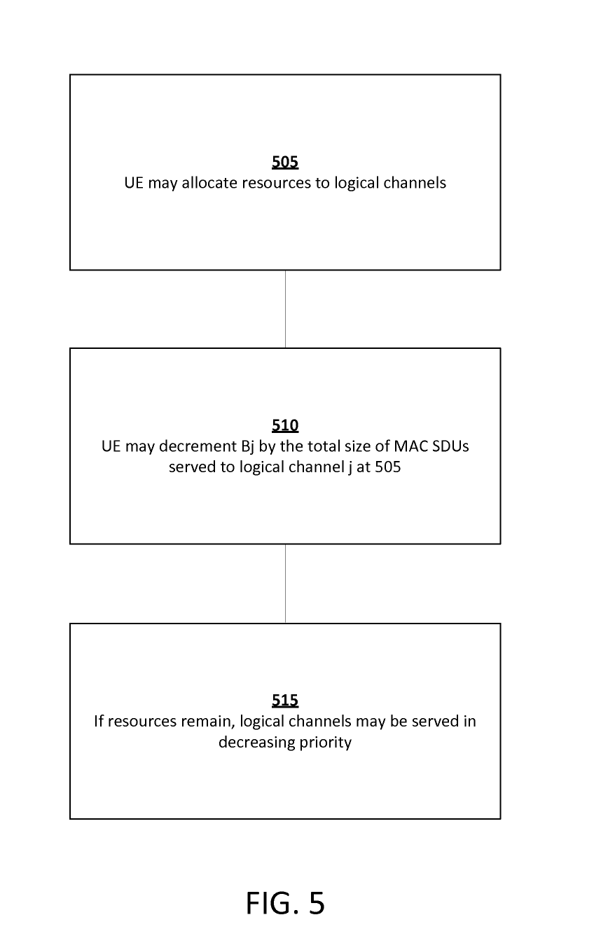

FIG. 5 depicts an example embodiment of a local channel prioritization (LCP) procedure. The LCP procedure may be applied when a new transmission may be performed. information regarding priority, prioritized bit rate (PBR), bucket size duration (BSD), or the like may be provided for a logical channel during configuration.

RRC may control the scheduling of uplink data by signaling for each logical channel. A UE may maintain a variable Bj for each logical channel j. Bj may be initialized to zero when the related logical channel may be established and incremented by the product PBR×TTI duration for each TTI, where PBR may be Prioritized Bit Rate of logical channel j. The value of Bj may not exceed the bucket size and if the value of Bj may be larger than the bucket size of logical channel j, it may be set to the bucket size. The bucket size of a logical channel may be equal to PBR×BSD, where PBR and BSD may be configured by upper layers.

A UE may perform a LCP procedure when a new transmission may be performed. Referring again to FIG. 5, at 505, a UE may allocate resources to the logical channels. Logical channels with Bj>0 may be allocated resources in a decreasing priority order. If the PBR of a radio bearer may be set to “infinity,” the UE may allocate resources for the data that may be available for transmission on the radio bearer before meeting the PBR of the lower priority radio bearer(s). If preferredTrChList may be provided, resources from preferred list may be used. Avoiding segmentation may be given priority over preferredTrChList, in which case the UE may not segment an RLC SDU (or partially transmitted SDU or retransmitted RLC PDU) if the whole SDU (or partially transmitted SDU or retransmitted RLC PDU) may fit into the resources on a non-preferred CC as long this may not belong to the refrainTrChList if present. If refrainTrChList may be provided, the system may avoid using the resources associated with this list.

At 510, the UE may decrement Bj by the total size of MAC SDUs served to logical channel j at 505. The value of Bj may be negative.

At 515, if any resources remain, the logical channels may be served in decreasing priority order, regardless of the value of Bj, until the data for that logical channel or the UL grant may be exhausted. Logical channels configured with equal priority may be served equally. If preferredTrChList may be provided, resources from preferred list may be used. Avoiding segmentation may be given priority over preferredTrChList, in which case the UE may not segment an RLC SDU (or partially transmitted SDU or retransmitted RLC PDU) if the whole SDU (or partially transmitted SDU or retransmitted RLC PDU) may fit into the resources on a non-preferred CC. If refrainTrChList may be provided, the system may ignore refrainTrChList or may avoid using the resources associated with refrainTrChList. The decision to ignore or use refrainTrChList may depend on the data flow, component carrier characteristics, and/or other implementation aspects.

During the scheduling procedures described herein, the may the UE may not segment an RLC SDU (or partially transmitted SDU or retransmitted RLC PDU) if the whole SDU (or partially transmitted SDU or retransmitted RLC PDU) fits into the remaining resources, the UE may maximize the size of the segment to fill the grant as much as possible if the UE segments an RLC SDU from the logical channel, the UE may maximize the transmission of data, or the UE may perform any combination thereof.

In the above procedure, the preferredTrChList and/or refrainTrChList lists may be selectively provided. If preferredTrChList and refrainTrChList lists may not be provided, LCP behavior may be the same as LTE-A Rel-10.

Methods and systems may be used for updating the traffic flow mappings. For example, these methods and systems may be used for configuration updates. preferredTrChList and refrainTrChList may be signaled in several different ways. For example, preferredTrChList and refrainTrChList may be signaled for a data radio bearer during a RRC configuration as shown below:

| | |
|---|---|
| DRB-ToAddMod ::= | SEQUENCE { |

| | | | |
|---|---|---|---|
| eps-BearerIdentity | INTEGER (0..15) | OPTIONAL, | -- Cond DRB-Setup |
| drb-Identity | DRB-Identity, | | |
| pdcp-Config | PDCP-Config | OPTIONAL, | -- Cond PDCP |
| rlc-Config | RLC-Config | OPTIONAL, | -- Cond Setup |
| logicalChannelIdentity | INTEGER (3..10) | OPTIONAL, | -- Cond DRB-Setup |
| logicalChannelConfig | LogicalChannelConfig | OPTIONAL, | -- Cond Setup |
| preferredTrChList | TrChList | OPTIONAL, | |
| refrainTrChList | TrChList | OPTIONAL, | |
| ... | | | |
| } | | | |

RRC reconfiguration messages may be used to update traffic flow mapping for a logical channel. When dedicated radio resource information may be provided for an existing data radio bearer, and when preferredTrChList and/or refrainTrChList may be provided, the UE may reconfigure the DTCH logical channel in accordance with the new preferredTrChList and/or refrainTrChList list information.

A MAC control element (CE) may be used to update traffic flow mapping or a logical channel. A MAC CE may be defined in such a way as to convey the component carrier preference data. For example, a MAC CE may be defined to convey preferredTrChList. As another example, a MAC CE may be defined to convey refrainTrChList. As another example, a MAC CE may be defined to convey both preferredTrChList and/or refrainTrChList for logical channels where data may be updated.

When a UE receives a MAC CE, the UE may update the corresponding traffic flow mapping information. A MAC CE may be conveyed in a different number of ways. preferredTrChList and refrainTrChList may be provided for each data radio bearer/logical channel during configuration. For each component carrier (cell) configured, the network may signal a list of data RBs (or logical channels) that may be preferred for this component carrier/transport channel and/or a list of data RBs that may not be allowed to be mapped for this component carrier/transport channel. For each component carrier (cell) configured, the network may signal a list of Logical channel groups (LCGs) that may be preferred and a list of LCGs that may not be allowed to be mapped for this component carrier/transport channel. These LCGs may be the same as that may be used for buffer status reporting (BSR), or the LCGs may be completely independent of LCGs defined for BSR reporting.

Grant request mechanisms may be provide for a component carrier. This may be done, for example, to allow a UE to request grants on a component carrier basis. For example, when using a license-exempt spectrum, the UE may requests a grant on a supplementary carrier such that the network may be aware that the UE may be seeking grants on license-exempt supplementary carrier as opposed to licensed carriers. This may, for example, enable a user downloading a HD movie to prevent the download from being counted towards a monthly quota on licensed carriers or enable the user to pay a flat rate to access supplementary carriers for such services.

Existing R-10 mechanisms allow buffer status reporting (BSR) to be done at a logical channel or logical channel group (LCG) level. However, this does not provide the network with any information regarding which carriers UE prefers to receive grants for. A carrier-status reporting mechanism is defined herein that may enable per component carrier grant requests. This mechanism may allow for status to be reported on a per carrier basis.

A plurality of component carriers may be grouped together to form a component carrier group (CCG) for status reporting purposes. This may be useful, for example, in scenarios where a group of carriers may be used for the same request, such as where a group of supplementary carriers may be available. The network may then signal which logical channels (or radio bearers) may be mapped to which component carriers.

For a logical channel or LCG, the network may provide a component carrier or CCG. The network may then use the BSR to decide on which component carrier it may provide additional grants. For a component carrier (cell) or component carrier group (CCG), the network may provide the UE with a list of preferred logical channels or logical channel group (LCG). With this additional configuration information, the existing R-10 BSR reporting mechanism may be utilized to achieve per component carrier (or CCG) status reporting.

The provision for the UE to request that certain higher layer services (or logical channels) be mapped to specific component carriers or CCGs may be done using UE capabilities, at the time of signing up for these higher layer services, or in the contract with the mobile operator/service provider. UE capabilities may be enhanced to indicate that UE may request grants on specific component carriers. This may enable a user to receive these services over the free carriers, which may be supplementary carriers, and the data usage on these carriers may not be counted towards a regular data usage quota. For example, a user may sign up for supplementary carriers and may select as user-preference or a package deal to receive higher layer services, such as NetFlix HD downloads, or the like over supplementary carriers.

As disclosed herein, D2D relays, such as UE-to-UE relays, may be useful, for example, when a T-UE may not have a good radio link with the eNB as there may be other UEs in the vicinity that may have better direct links. These UEs may act as helper UEs (H-UES) and may increase the throughput to the T-UE by relaying data from and to the eNB.

In capacity solution, a TRL may exist between eNB and T-UE. In addition, the XL between H-UE and T-UE may provide a mechanism to allow higher data rate applications to be serviced in T-UE. Higher layer control information, such as system information, paging, RACH access, RRC, NAS signaling (signaling radio bearers), multicast traffic, or the like may be transmitted on a radio link from the eNB to the T-UE. This traffic may not be routed via H-UE.

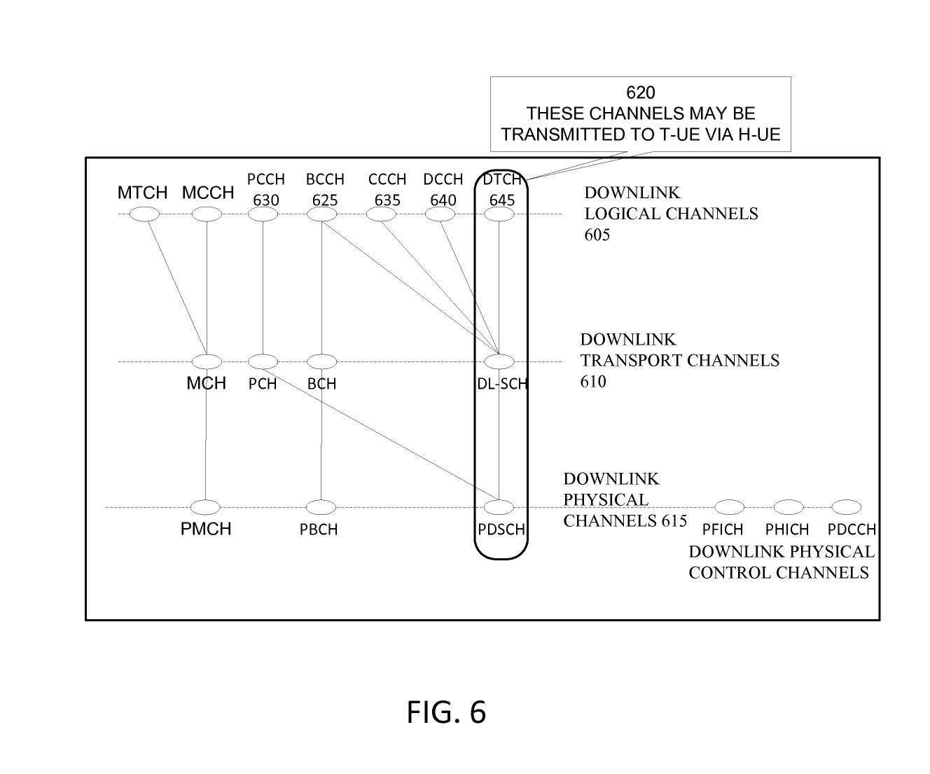

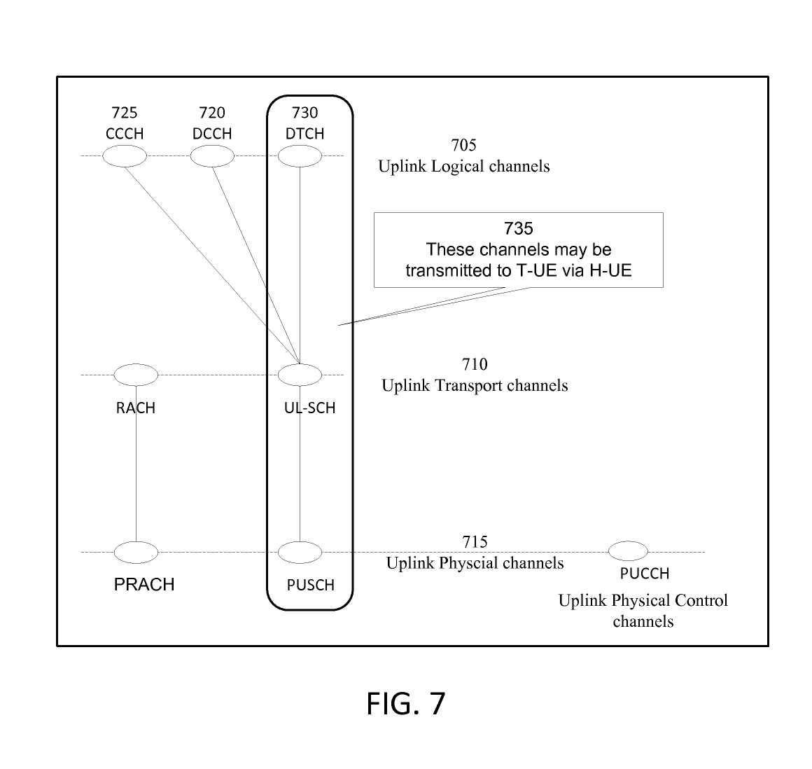

FIGS. 6 and 7 may highlight the logical and transport channels that may be mapped in DL and UL respectively to be transmitted via H-UE. FIG. 6 and FIG. 7 are shown for illustrative purposes. These figures highlight what logical and transport channels may be routed via H-UE and what logical and transport channels may be routed directly to T-UE without the assistance of H-UE. For instance, multiple DTCHs may be mapped to PDSCH/PUSCH to be transmitted via H-UE.

FIG. 6 depicts an example embodiment for downlink logical and transport channels for capacity relay. For example, FIG. 6 may depict capacity relay for downlink logical channels 605, downlink transport channels 610, and/or downlink physical channels 615. In downlink, there may be two or more instantiations of PDSCH. One PDSCH instantiation may be for carrying logical channels paging control channel (PCCH) 630, broadcast control channel (BCCH) 625, common control channel (CCCH) 635, one or more dedicated control channels (DCCH), such as DCCH 640, and one or more dedicated traffic channel (DTCH), that may be routed directly to T-UE without the assistance of H-UE. DTCH mapped to PDSCH may be carrying low data rate services, such as voice. At 620, another PDSCH instantiation may be for carrying DTCH logical channel data, which may be from DTCH 654, to be routed via H-UE to T-UE.

FIG. 7 depicts an example embodiment for an uplink logical and transport channel for capacity relay. In uplink, there may be two or more instantiations of PUSCH. One PUSCH instantiation may be for carrying logical channels CCCH, such as CCCH 725, one or more DCCH, such as DCCH 720, and one or more DTCH to be routed directly to eNB without the assistance of H-UE. DTCH mapped to PDSCH may be carrying low data rate services, such as voice. At 735, another PDSCH instantiation may be for carrying DTCH logical channel data, which may be from the DTCH 730, that may be routed via H-UE to eNB.

For D2D relay in topologies, specific DTCH traffic may be routed using H-UE. Other traffic, such as broadcast, paging, multicast, SRBs, or the like may be routed directly between an eNB and a T-UE. Two instantiations of PDSCH may be processed in DL and two instantiations of PUSCH may be in UL. Mechanisms may provide the ability to map DTCH traffic over PDSCH that may be routed via H-UE. A logical channel prioritization module may be used to route DTCH logical channel traffic via cross link (XL) using H-UE and to route other traffic, such as broadcast, paging, multicast, SRBs, or the like via a traditional link (TRL).

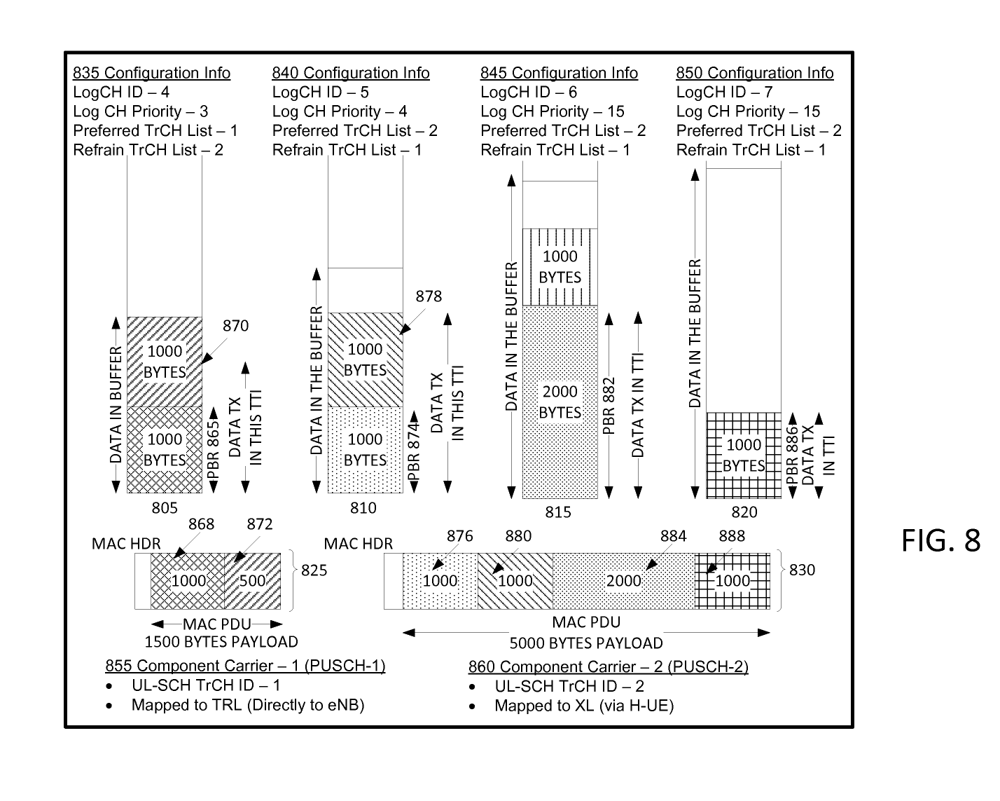

FIG. 8 depicts an example embodiment of a modified logical channel prioritization (LCP) for D2D capacity mode. Logical channels that may be routed via the XL may be configured with preferredTrChList and refrainTrChList lists such that PDSCH and PUSCH may be mapped to H-UE may be used for routing this traffic. FIG. 8 may illustrate how this may work.

As shown in FIG. 8, and UE may be configured in the UL to have four logical channels, such as at 805, 810, 815, and 820, and two component carriers, such as at 855, and 860. Component carrier 1 at 855 may correspond to transport channel 1 at 825. Component carrier 2 at 860 may correspond to transfer channel 2 at 830.

Configuration information, such as configuration information 835, 840, 845, and 850, may be provided. The configuration information may be for the logical channels and may include logical channel ID, priority, preferred and refrained transport channel lists. A lower logical channel priority number may be given higher the priority

Configuration information 835 may indicate that logical channel 4 at 805 may have a priority of 3, that the preferred transport channel may be transport channel 1 at 825, and that the refrained transport channel may be transport channel 2 at 830. Configuration information 840 may indicate that logical channel 5 at 810 may have a priority of 4, that the preferred transport channel may be transport channel 2 at 830, and that the refrained transport channel may be transport channel 1 at 825. Configuration information 845 may indicate that logical channel 6 at 815 may have a priority of 15, that the preferred transport channel may be transport channel 2 at 830, and that the refrained transport channel may be transport channel 1 at 825. Configuration information 850 may indicate that logical channel 7 at 820 may have a priority of 15, that the preferred transport channel may be transport channel 2 at 830, and that the refrained transport channel may be transport channel 1 at 825.

Component carrier 1 at 855 may be PUSCH-1 and may be configured to be sent to eNB on TRL. Component carrier 2 may be PUSCH-2 and may be configured to be sent to eNB via H-UE on XL.

Priority order may be provided for transport channels in preferredTrChList. For example, configuration information 835 may indicate it may be preferred to send data on component carrier 1, which may be PUSCH-1 (TRL), for logical channel 4 at 805. Configuration information 835 may indicate that channel 4 data may be refrained from mapping its data to component carrier 2 at 830, which may be PUSCH-2. For logical channels 5 (at 840), 6 (at 845), 7 (at 850) it may be preferred to send data on PUSCH-2 (XL). Logical channel data for logic channels 5, 6, and 7 may be refrained from mapping its data to PUSCH-1 (TRL). A MAC payload size, which may be based on UL grant, for component carrier 1, which may be PUSCH-1, may be shown at 825. A MAC payload size, which may be based on UL grant, for component carrier to, which may be PUSCH-2, may be shown at 830.

Logical channel 4 may have the highest priority and its PBR data may be mapped to PUSCH-1 due to its preferredTrChList. Due to refrainTrChList configuration. For logical channel 4, data from logical channel 4 may not be mapped to PUSCH-2 even though logical channel 4 may have higher priority than logical channels 5, 6 and 7. For example, at 868, PBR data at 875 from logical channel 4 may be mapped to component carrier 1. At 872, data at 870 from logical channel 4 may be mapped to component carrier 2 as configuration information 835 may indicate that data from logical channel 4 may not be mapped to component carrier 2.

Data from logical channels 5, 6, and 7 may be mapped to component carrier 2, which may be PUSCH-2, as per the respective preferredTrChList mapping. Prioritization of data between logical channels 5, 6, and 7 may follow baseline LCP rules. For example, because logical channel 5 may have a higher priority than logical channel 6 or logical channel 7, at 876, PDR data 874 from logical channel 5 may be mapped to component carrier 2. At 880, data at 878 from logical channel 5 may be mapped to component carrier 2 as logical channel 5 may have a higher priority than logical channel 6 and logical channel 7, which may have data. Logical channel 6 and logical channel 7 may have identical priority. At 884, PBR data at 882 from logical channel 6 may be mapped to component carrier 2. At 888, PBR data at 886 from logical channel 7 may be mapped to component carrier 2, even though logical channel 5 may still have data to transmit.

A UE may be configured with one primary cell (PCell) and zero or more secondary cells (SCells). If the UE may be configured with one or more SCells, there may be multiple DL-SCH and there may be multiple UL-SCH per UE; one DL-SCH and UL-SCH on the PCell, one DL-SCH and zero or one UL-SCH for each SCell.

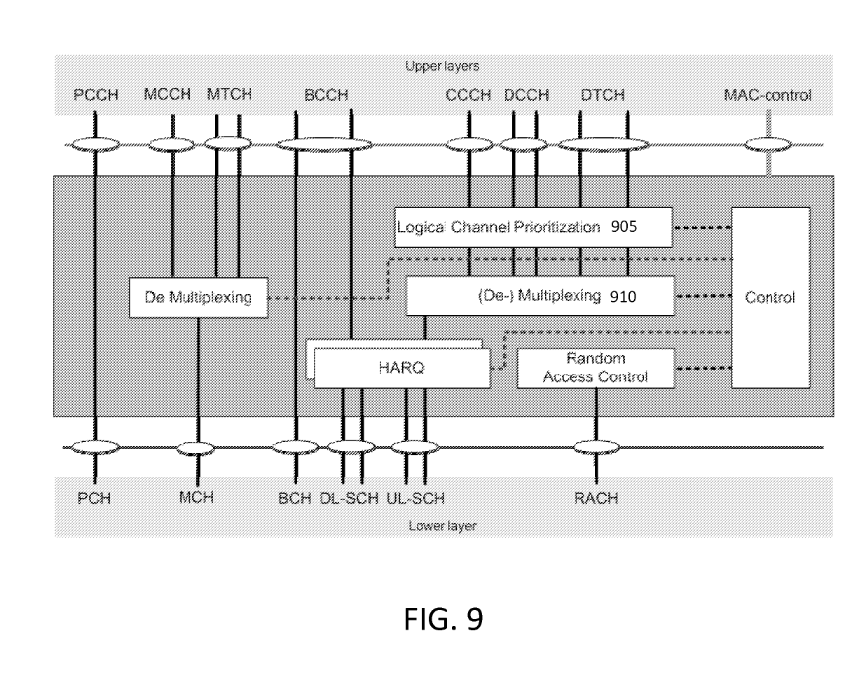

FIG. 9 depicts an example embodiment of a medium access control (MAC) structure overview from a UE perspective. In the UE uplink direction, higher layer data received at MAC UL for DCCH/DTCH traffic may go through a logical channel prioritization (LCP) module at 905 followed by (De-) Multiplexing unit at 910. Output of this data may be mapped to any component carrier.

Supplementary Carriers may be subject to “listen-before-talk” or sensing to determine suitability before transmission. Carrier sensing may be required for supplementary carriers due to co-existence with other RATs. The supplementary carrier may have a dynamic nature as the UE may not be able to make use of the transmission opportunity as the channel may be occupied by another secondary user of another RAT even though an uplink soft-grant may be allocated by eNB.

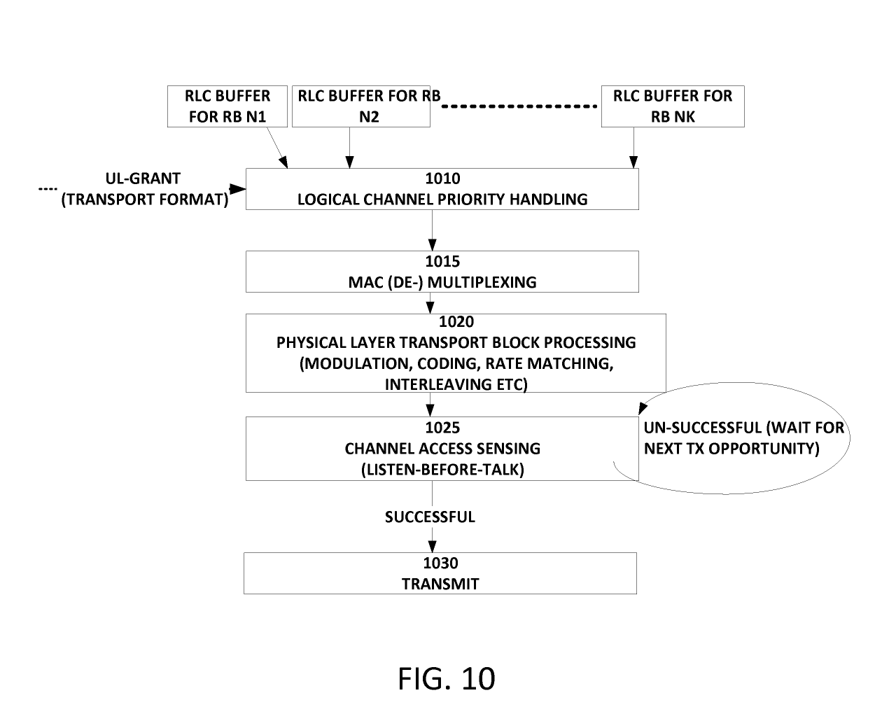

FIG. 10 depicts an example embodiment of transport block processing in uplink (UL) for a supplementary carrier. At 1010, logical channel priority handling may be performed. At 1015, MAC multiplexing or MAC demultiplexing may be performed. At 1020, physical layer transport block processing, such as modulation, coding, rate matching, interleaving, or the like may be performed.

At 1025 channel access sensing may be performed. The UE may have to prepare the transport block based on a soft-grant provided by eNB for supplementary carrier and may have to perform channel access sensing before transmission. When channel access sensing may be successful, the UE may transmit the transport block on a supplementary carrier at 1030. When channel's access sensing may be unsuccessful, the UE may wait for the next transmission opportunity based on soft-grant.

Mechanisms may be provided to provide for the dynamic nature of supplementary carriers such that data may be mapped to a component carriers(s). This may be done, for example, to avoid delaying real-time traffic by waiting for the next transmission opportunity in license-exempt carrier aggregation framework.

While supplementary carriers availability may be dynamic in nature and other secondary users of a different RAT may occupy the supplementary carriers, on an average their availability over a pool of supplementary carriers configured at the UE may be able to support delay tolerant data. Soft-grants for supplementary carriers may be typically provided to the UE in a semi-persistent fashion.

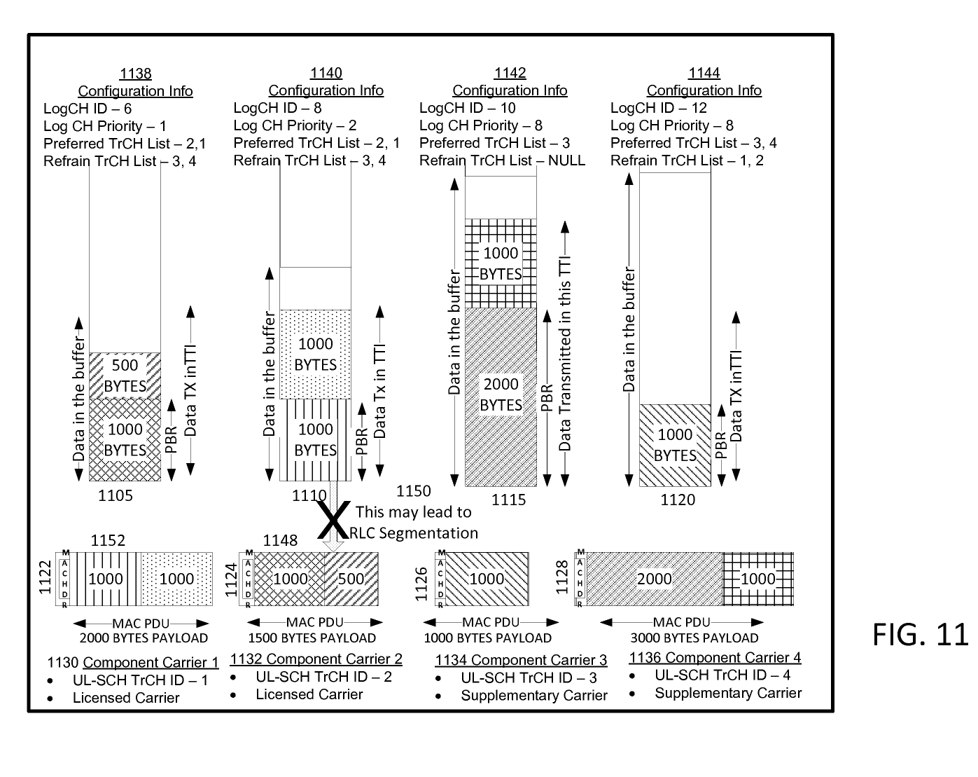

FIG. 11 depicts an example embodiment of a modified LCP for license exempt (LE) carrier aggregation. In a license-exempt carrier aggregation framework it may not be preferred to map real-time or near real-time traffic to supplementary carriers.

As shown in FIG. 11, a UE may be configured in the UL to have four logical channels, such as 1105, 1110, 1115, and 1120, and four component carriers, such as 1130, 1132, 1134, and 1136. Component carrier 1 at 1130 may correspond to transport channel 1 at 1122. Component carrier 2 at 1132 may correspond to transport channel 2 at 1110. Component carrier 3 at 1134 may correspond to transport channel 3 at 1126. Component carrier 4 at 1136 may correspond to transport channel 4 at 1128.

Configuration information, such as configuration information 1138, 1140, 1142, and 1144, may be provided. The configuration information may be for the logical channels and may include logical channel ID, priority, preferred and refrained transport channel lists. A lower logical channel priority number may be given higher the priority

Configuration information 1138 may indicate that logical channel 6 may have a priority of 1, that the preferred transport channel may be transport channel 2 at 1132 and/or transport channel 1 at 1130, and that the refrained transport channels may be transport channel 3 at 1134 and/or transport channel 4 at 1136. Configuration information 1140 may indicate that logical channel 8 may have a priority of 2, that the preferred transport channel may be transport channel 2 at 1132 and/or transport channel 1 at 1130, and that the refrained transport channels may be transport channel 3 at 1134 and/or transport channel 4 at 1136. Configuration information 1142 may indicate that logical channel 10 may have a priority of 8, that the preferred transport channel may be transport channel 3 at 1126, and that there may not be a refrained transport channel. Configuration information 1144 may indicate that logical channel 12 may have a priority of eight, that the preferred transport channel may be transport channel 3 at 1126 and/or transport channel 4 at 1128, and that the refrained transport channels may be transport channel 1 at 1122 and/or transport channel to at 1124. Component carrier 1 (1130) and component carrier 2 (1132) may be licensed carriers. Component carrier 3 (1134) and component carrier 4 (1136) may be supplementary carriers which may belicense-exempt.

As shown in FIG. 11, logical channel 6 may have a priority of 1, logical channel 8 may have a priority of 2, logical channel 10 may have a priority of 8, and logical channel 12 may have a priority of 8. A lower logical channel priority number may indicate higher priority. Priority order may be provided for transport channels in preferredTrChList. When refraintTrChList may be provided, logical channels may be instructed not to use resources associated with this list. For example, for logical channel 6 it may be preferred to send data on component carrier 2 as opposed to component carrier 1. Logical channel 6 data may be refrained from mapping its data to component carriers 3 and 4. Similar logic may apply to other logical channel configurations as well.

At 1142, a refrain transport channel list may not be provided for logical channel 10, but a preferredTrChList of 3 and 4 may be provided. This may imply that for logical channel 10, it may be preferred that data for logical channel 10 be mapped to component carriers 3 or 4 but there may be no restrictions in terms of which carriers the data may not be mapped to. For example, logical channel 10 may be mapped to component carriers 1 and 2. MAC payload sizes, that may be based on UL grant, for each of the corresponding component carriers may also be shown in FIG. 11. For supplementary carriers (3 and 4), this may be provided in the form of soft-grant.

Logical channel 6 at 1105 may have the highest priority and its PBR data at its 1146 may be mapped to component carrier 2 at 1148 per its preference. At 1150, data from logical channel 8 may not be mapped to component carrier 2 even this may be the first preference for logical channel 8 as this may lead to RLC segmentation. Instead, at 1152, logical channel 8 data may be mapped to component carrier 1. Logical channels 10 and 12 have equal priority of 8. PBR data 1154 from logical channel 10 may not be mapped to component carrier 3 to avoid RLC segmentation. Because a refraintTrChList may be specified, data from logical channels 6 and 8 may be refrained from mapping to component carriers 3 and 4. Even though data may be available in logical channel 8 buffer, it may not be transmitted on component carriers 3 or 4.

Embodiments described herein may also be applicable to multi-site carrier aggregation. For example, real-time services may be mapped over cell1 and non real-time services may be mapped over cell2, which may incur additional delay due to X2 interface along with additional processing delay at eNB of cell2. This may be done, for example, to reduce latency, provide traffic offload, QoS, reduce interference, improve capacity or other specific implementation specific reasons. To provide the ability to map specific traffic/services over different cells, traffic flow mapping may be used with the LCP updates described herein.

Due to better penetration or other significant characteristics of bands in lower frequencies (as compared those in higher frequencies), it may be preferred to map real-time services over lower frequency bands. To provide ability to map specific traffic/services over different component carriers, traffic flow mapping may be used with LCP updates and grant request mechanisms as described herein.

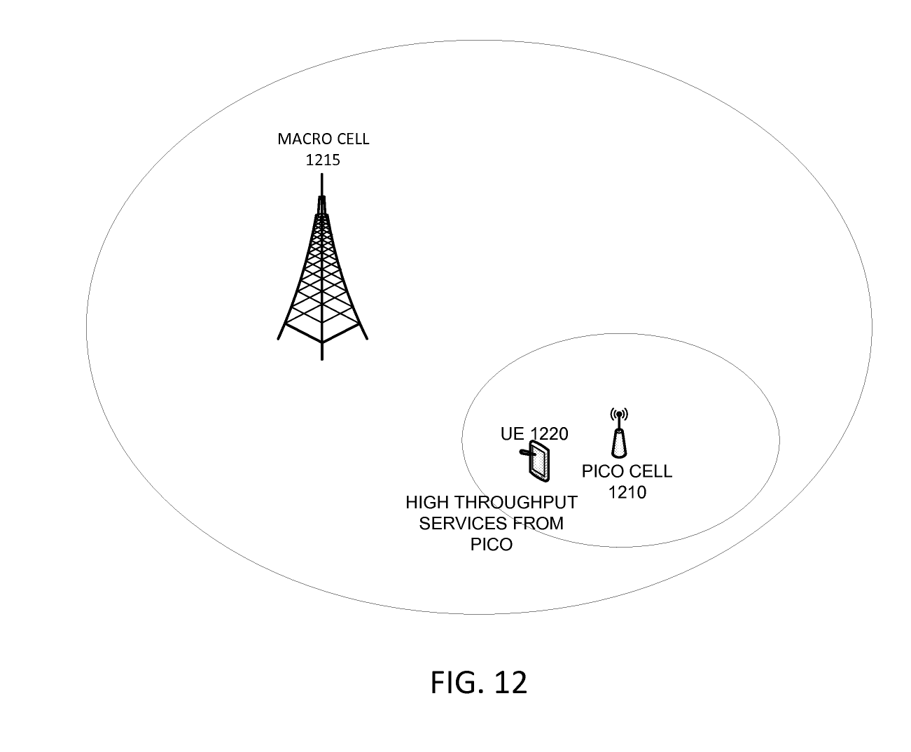

FIG. 12 depicts an example embodiment for macro plus hotspot coverage. The embodiments described herein may be used for macro cell and hotspot coverage. For example, high throughput services may be provided by a pico cell and low throughput services. As shown in FIG. 11, in macro and hotspot coverage scenarios high throughput services may be provided by pico cell 1210 and low throughput services along with mobility might be provided by macro cell 1215. Mechanisms may be provided to map specific traffic/services to different cells. For example, embodiments disclosed herein may be used to map high throughput services from pico cell 1210 to UE 1220 while macro cell 1215 provides low throughput and mobility services to UE 1220. This may be accomplished, for example, by using traffic flow mapping along with LCP updates and grant request mechanisms described herein.

A method may be used to map data to a component carrier. A wireless transmit/receive unit may obtain a plurality of data blocks. Each data block may be associated with at least one of a plurality of logical channels. Radio transmission resources may be allocated for transmission of the plurality of data blocks by mapping each data block to a radio transmission resource based on a component carrier preference data. The mapping of each data block to a radio transmission resource may be based on a logical channel prioritization parameter associated with the data block. The mapping of each data block to a radio transmission resource may be based on preventing data block segmentation such that a data block may be mapped to a non-preferred component carrier when data block segmentation may be required on a preferred component carrier and may not be required on the non-preferred component carrier. The mapping of each data block to a radio transmission resource may be based on a quality of service parameter such that guaranteed bit rate traffic may be prevented from being routed to a supplementary carrier.

The radio transmission resources may include a transport channel, a component carrier, a primary carrier, a supplemental carrier, or the like. The supplemental carrier may be in a license exempt spectrum. The component carrier preference data may include a component carrier preference list for at least one logical channel, and/or a component carrier exclusion list for at least one logical channel.

The plurality of data blocks may be transmitted using the allocated radio transmission resources. A radio resource control (RRC) message, a medium access control (MAC) message, or the like may be transmitted to request configuration of the a logical channel from the plurality of logical channels. A configuration for the logical channel, which may be from the plurality of logical channels, may be received.

A method may be used to mapped data to a H-UE such that the data may be transmitted to a eNB via the H-UE. A first wireless transmit/receive unit (WTRU) may obtain a plurality of data blocks. Each data block may be associated with at least one of a plurality of logical channels. The first WTRU may determine a second WTRU that may have a first radio link to a evolved node B (eNB) and a second radio link to the first WTRU. The second WTRU may be a H-UE.

Radio transmission resources may be allocated for transmission of the plurality of data blocks by mapping each data block to a radio transmission resource based on a component carrier preference data. The mapping of each data block to a radio transmission resource may be based on data throughput such that a data block may be mapped to the second radio link when transmitting the data block via the second WTRU provides higher throughput. The mapping of each block to a radio transmission resource may be based on quality of service parameter such that a data block may be mapped to the second radio link when the first radio link may have less interference than a third link from the first WTRU to the eNB. The mapping of each block to a radio transmission resource may be based on data throughput such that a data block may be mapped to the second radio link when the first radio link may have a higher throughput than a third link from the first WTRU to the eNB. The mapping of each data block to a radio transmission resource may be based on preventing data block segmentation such that a data block may be mapped to a non-preferred component carrier when data block segmentation may be needed on a preferred component carrier and not needed on the non-preferred component carrier.

The radio transmission resource may include the second radio link. The radio transmission resources may include a transport channel, a component carrier, a supplementary carrier, the second WTRU, a H-UE, or the like. The component carrier preference data may comprise a component carrier preference list for at least one logical channel, a component carrier exclusion list for at least one logical channel, or the like. The plurality of data blocks may be transmitted using the allocated radio transmission resources. For example, a data block may be transmitted to the eNB via the second WTRU.

A method may be used for requesting a grant for a component carrier. A plurality of logical channels may be determined. A wireless transmit/receive unit may generate a status message for at least one of a plurality of component carriers that may be used for transmitting data from the plurality of logical channels. It may be determined that resources may be needed for the component carrier using the status message.

A grant request for the component carrier may be transmitted. The status message may be transmitted for the at least one of the plurality of component carriers. The status message may provide status for a component carrier, a component carrier group, or a combination thereof. The component carrier group may make up a portion of the plurality of component carriers.

Determining that resources may be needed for the component carrier may include determining from the status message that the plurality of logical channels prefer to transmit data using the component carrier. Determining that resources may be needed for the component carrier may include determining from the status message that data from the plurality of logical channels to be transmitted on the component carrier may exceed granted resources for the component carrier. Component carrier preference may also be used to determine that resources may be needed for the component carrier. The component carrier may be a in a licensed spectrum, license-exempt spectrum. The component carrier may be a supplementary carrier or a primary carrier.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-28. (canceled)

29. A method comprising:
receiving a data block from a logical channel;
mapping the data block to a radio transmission resource using a logical channel prioritization parameter and a component carrier preference data for the logical channel;
sending the data block using the radio transmission resource.

30. The method of claim 1, wherein the radio transmission resource comprises a transport channel or a component carrier.

31. The method of claim 1, wherein the component carrier preference data comprises a component carrier exclusion list for the logical channel.

32. The method of claim 1, wherein mapping the data block to the radio transmission resource prevents data block segmentation such that the data block is mapped to a non-preferred component carrier when data block segmentation would occur on a preferred component carrier.

33. The method of claim 1, wherein the radio transmission resource comprises a primary carrier and a supplemental carrier.

34. The method of claim 5, wherein the supplemental carrier is in a license-exempt spectrum.

35. The method of claim 1, further comprising:
sending a radio resource control (RRC) message requesting configuration of the logical channel; and
receiving configuration for the logical channel.

36. The method of claim 1, further comprising:
sending a medium access control (MAC) message requesting configuration of the logical channel; and
receiving configuration for the logical channel.

37. The method of claim 5, wherein mapping the data block to the radio transmission resource is further comprises using a quality of service parameter such that guaranteed bit rate traffic is prevented from being routed to a supplementary carrier.

38. A method comprising:
obtaining, via a first wireless transmit/receive unit (WTRU), a data block associated with a logical channel;
determining a second WTRU that has a first radio link to a evolved node B (eNB) and a second radio link to the first WTRU;
mapping the data block to a radio transmission resource using a component carrier preference data for the logical channel, the radio transmission resource including the second radio link;
sending the data block using the radio transmission resource.

39. The method of claim 10, wherein sending the data block comprises sending the data block to the eNB via the second WTRU.

40. The method of claim 10, wherein mapping the data block to the radio transmission resource comprises ensuring the data block is mapped to the second radio link when sending the data block via the second WTRU provides higher throughput.

41. The method of claim 10, wherein mapping the data block to the radio transmission resource further comprises using a quality of service parameter such that the data block is mapped to the second radio link when the first radio link has less interference than a third link from the first WTRU to the eNB.

42. The method of claim 10, wherein mapping the data block the radio transmission resource comprises ensuring that the data block is mapped to the second radio link when the first radio link has higher throughput than a third link from the first WTRU to the eNB.

43. The method of claim 12, wherein the radio transmission resource further comprises a transport channel or a component carrier.

44. The method of claim 12, wherein the component carrier preference data comprises a component carrier preference list for the logical channel.

45. The method of claim 16, wherein the component carrier preference data comprises a component carrier exclusion list for the logical channel.

46. The method of claim 12, wherein the mapping the data block to the radio transmission resource comprises preventing data block segmentation such that the data block is mapped to a non-preferred component carrier when data block segmentation would occur on a preferred component carrier.

47. A method comprising:
generating, via a wireless transmit/receive unit, a status message for a component carrier, wherein the component carrier is used to send data for a logical channel;
determining a resource for the component carrier using the status message; and
sending a grant request to request the resource for the component carrier.

48. The method of claim 19, further comprising determining from the status message that the logical channel prefers to send data using the component carrier.

49. The method of claim 19, further comprising determining from the status message that data to be sent on the component carrier exceeds granted resources for the component carrier.

50. The method of claim 19, wherein the component carrier is a supplementary carrier.

51. The method of claim 19, wherein the component carrier is in a license-exempt band.

51. The method of claim 19, wherein the status message provides status for a component carrier group.
